(19) United States
(12) Patent Application Publication
(10) Pub. No.: US 2024/0140323 A1
(43) Pub. Date: May 2, 2024

(54) Tire Mounted Accessory System

(71) Applicant: Glen Heacock, Sellersburg, IN (US)

(72) Inventor: Glen Heacock, Sellersburg, IN (US)

(21) Appl. No.: 18/491,068

(22) Filed: Oct. 20, 2023

Related U.S. Application Data
(60) Provisional application No. 63/381,969, filed on Nov. 2, 2022.

(51) Int. Cl. B60R 9/06

(52) U.S. Cl. CPC B60R 9/06

(57) ABSTRACT

A tire mounted accessory system provides a secure way for mounting accessories to an automobile, using an externally mounted tire as a mounting point. The external spare provides solid mounting surface for attaching tire mounted accessory system without interfering with access to the trunk or rear hatch of the vehicle, and it may be installed and removed without making permanent modifications to the vehicle frame or chassis. A tire mounted accessory system may include a first and second horizontal rail spaced parallel to one another, as well as a first and second vertical rail spaced parallel to one another and perpendicular to the horizontal rails, with each rail having mounting points capable of mounting accessories via a plurality of brackets, which are herein disclosed.

### CROSS-REFERENCE TO RELATED APPLICATIONS

This application claims priority from U.S. Provisional Application No. 63/381,969 filed on Nov. 2, 2022, the full disclosure of which is hereby incorporated by reference.

### BACKGROUND

The present disclosure relates to vehicle accessory mounting systems, and vehicle accessories, configured to attach to the external tire of an automobile, and methods for using the same.

Automobile enthusiasts have long enjoyed an interest in vehicle customizations and accessories both for their utility and as an expression of the user's personality. In recent years, this interest has grown among owners of recreational vehicles, sport utility vehicles and jeep-style automobiles.

With respect to vehicles such as the Jeep® Wrangler®, the ability to add accessories or customize the rear of the vehicle has traditionally been constrained by the presence of an externally mounted spare tire. Users have been able to modify the stock configuration of their vehicles with accessories such as graphical tire covers or aftermarket back-up cameras. See, e.g., U.S. Pat. Pub'n 2008/0023507 A1, U.S. Pat. No. 11,110,976 B1. However, such accessories are typically limited to a single or limited function and may be difficult to quickly install or uninstall without tools.

Alternative accessory systems exist that may be affixed to different locations on such vehicles, such as a trailer hitch. See, e.g., U.S. Pat. No. 8,276,932 B2. However, these accessory mounting systems can interfere with the operation of the vehicle's trunk or rear door, particularly in the presence of said externally mounted spare tires.

A need therefore exists for a multi-purpose tire mounted accessory system that can be configured to accommodate a variety of externally mounted spare tires, which can be easily installed or removed without tools or with minimal tool use, which does not interfere with full use of the vehicles rear door, and can accommodate a wide variety of accessory devices and functions, including cameras, camping lights, loudspeakers, baskets, containers, flagpoles, bicycle rack, snowboard rack or tables.

### SUMMARY

This disclosure is directed to tire mounted accessory systems, and methods of attaching tire mounted accessory systems to an automobile tire.

In one embodiment, a tire mounted accessory system is disclosed comprising first horizontal rail having at least one mounting point comprising a pinhole, a second horizontal rail substantially parallel to the first horizontal rail having at least one mounting point comprising a pinhole, a first vertical rail oriented substantially perpendicular to the first horizontal rail and second horizontal rail having at least one mounting point comprising a pinhole, and a first tire connector connected to a mounting point. A second vertical rail oriented substantially parallel to the first vertical rail and substantially perpendicular to the first horizontal rail and second horizontal rail may also be included. Along with the second vertical rail, a tire mounted accessory system may also include vertical connecting bars configured to connect the vertical rails to the horizontal rails. In some configurations, the tire mounted accessory system may include a second, third or fourth tire connector, with each tire connector configured to mount to the tire mounted accessory system at the intersection of a vertical and horizontal rail, allowing the tire mounted accessory system to attach to a vehicle tire at four or more locations.

The tire mounted accessory system may further be configured to work with a variety of accessories, which may be attachable to one or more mounting points, and can accommodate accessories such as a bumper, a span, a basket or a bicycle rack. It may connect such accessories via a number of brackets, which are disclosed herein.

The tire mounted accessory system may further comprise a number of expansion legs, with each expansion leg being connected to a vertical or horizontal rail via a bracket, and said expansion legs having mounting points capable of mounting accessories as substantially disclosed herein. Multiple expansion legs may also be used in tandem to support accessories that require multiple attachment points to support.

Also disclosed herein is a method of attaching a tire mounted accessory system to an automobile tire, including steps such as providing a tire mounted accessory system including a first horizontal rail, a second horizontal rail, a first vertical rail, a second vertical rail, a first tire connector, a second tire connector, a third tire connector, and a fourth tire connector, and a plurality of brackets, attaching the first vertical rail to a first end of the first horizontal rail via a bracket and a second vertical rail to a second end of the first horizontal rail substantially opposite to the first horizontal rail via a bracket, attaching the first tire connector at the intersection of the first vertical rail and first horizontal rail and the second tire connector at the intersection of the second vertical rail and first horizontal rail, placing the first tire connector and second tire connector in contact with an automobile tire, orienting the second horizontal rail parallel to the first horizontal rail and attaching said second horizontal rail to the first vertical rail via a bracket and attaching the second horizontal rail to the second vertical rail via a bracket.

### DESCRIPTION OF THE DRAWINGS

FIG. 1 is a perspective view of a tire mounted accessory system.

FIG. 2A is a perspective view of universal accessory bracket for a tire mounted accessory system having an accessory.

FIG. 2B is a perspective view of universal accessory bracket for a tire mounted accessory system having an accessory.

FIG. 2C is a perspective view of universal accessory bracket for a tire mounted accessory system having an accessory.

FIG. 3 is a is a perspective view of universal accessory bracket for a tire mounted accessory system having an expansion leg.

FIG. 4A is a perspective view of a tire mounted accessory system including a plurality of expansion legs.

FIG. 4B is a perspective view of a tire mounted accessory system including a plurality of expansion legs.

FIG. 5 is a flowchart of the usage.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

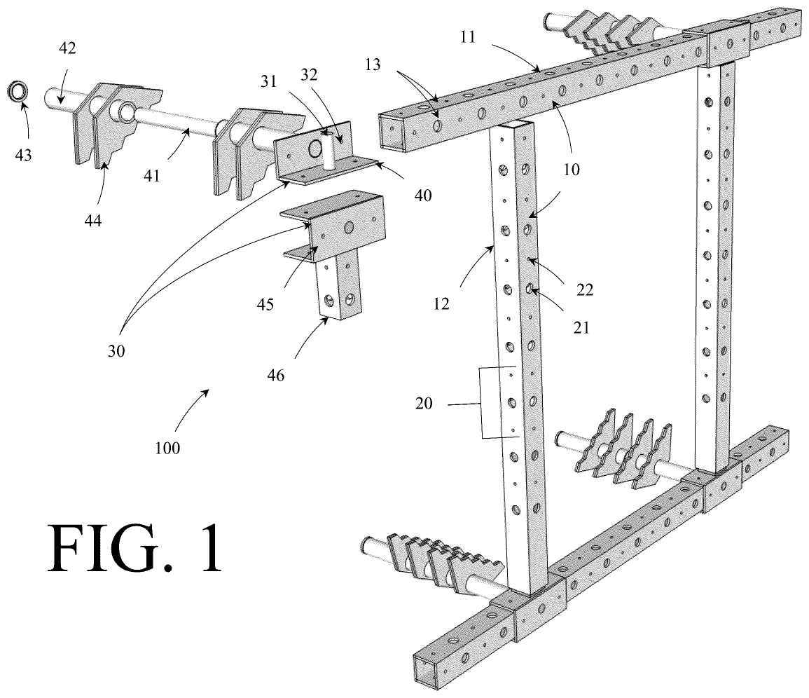

Referring to FIG. 1, a tire mounted accessory system 100 may include a plurality of rails 10, including a plurality of horizontal rails 11 oriented substantially parallel to one another, and a plurality of vertical rails 12 oriented substantially parallel to one another and perpendicular to horizontal rails 11. According to one embodiment, each rail 10 may be constructed of a resilient, load-bearing material such as square tube steel, aluminum, carbon fiber or similar high strength material, with each rail having a plurality of mounting surfaces 13. For example, a square tube steel rail 10 may have up to four mounting surfaces 13 corresponding to the four sides of said rail 10. In other embodiments, rail 10 may have fewer mounting surfaces than the sides of said rail 10 where, for example, the additional mechanical strength of said rail afforded by having fewer perforations is desirable. Each mounting surface 13 may be comprised of a plurality of mounting points 20. According to one embodiment, rails 10 may be left open on their proximal or distal ends to accommodate additional components that may be inserted therein.

Mounting points 20 may be comprised of a pinhole 21, sized to accommodate a pin 31 of a material and thickness sufficient to support significant mechanical loads under conditions that an automobile would reasonably be subjected to, including rough roads or offroad driving, or wind force at highway speeds. Pins 31 may be of a variety of lengths. According to some embodiments, pin 31 is longer than the width of rail 10, permitting said pin 31 to be inserted into one pinhole 31 on one side of said rail, and extend through a second pinhole 31 on an opposite side of said rail 10. According to another embodiment, pin 31 may be only marginally longer than the material thickness of rail 10, allowing pin 31 to be inserted into pinhole 21 without mechanically interfering with other pins 31 inserted through the pinholes 21 on parallel or perpendicular mounting surfaces 13 of the same rail 10. Mounting points 20 may also be comprised of a plurality of locking holes 22, which may be threaded, and which may be sized and configured to accommodate a mechanical fastener such as a machine screw. According to some embodiments, locking holes 22 are sized and threaded to accommodate standard machine screws, such as screw sizes #0 to #12, to enable accessories or components to be attached to mounting points 20 directly using off the shelf parts.

Mounting points 20 may be configured to accommodate a variety of brackets 30. For example, a tire connector bracket 40 may take the form of an L-shaped bracket having a horizontal side and a vertical side, with a pin 31 disposed on the inner face of the horizontal side and a connecting rod 41 affixed at the proximal end to the outer face of the vertical side, with corresponding locking holes 32 disposed on both the horizontal and vertical sides. Connecting rod 41 may be configured to accommodate one or more sleeves 42 that may be slidably inserted onto connecting rod 41 and secured in place with an end cap 43. End cap 43 may be in the form of a screw or bolt and may interface with a threaded portion located at the distal end of connecting rod 41. Sleeves 42 may further comprise a plurality of cleats 44, configured to contact the exterior surface of an automobile tire to be held in place with friction force.

According to one embodiment, cleats 44 may be offset from the longitudinal center of sleeve 42, so that two sleeves 42 may be placed on connecting rod 41 either with the cleats 44 oriented close to one another, or with one or both sleeves reversed so that cleats 44 are spaced farther apart to accommodate a wider tire. Each sleeve 42 may be configured to rotate freely about connecting rod 41, so that cleats 44 may contact the tire surface with an optimal amount of surface area no matter where on said tire they contact. This allows tire mounted accessory system 100 to be installed on a variety of tire sizes, without requiring the horizontal rails 11 and vertical rails 12 to be precisely positioned, so long as they are spaced apart at substantially less distance than the diameter of said tire.

According to one embodiment, tire connector bracket 40 may be connected to horizontal rail 11 by inserting pin 31 through pinhole 21 located on an upper or lower face of horizontal rail 11, which would align locking holes 22 with corresponding locking holes 32, allowing a mechanical fastener to be inserted therein to secure tire connector bracket 40 in place. Connecting rod 41 may then be slidably inserted into one or more sleeves 42, which may be positioned longitudinally by the user to contact the tire surface at mechanically secure point. Then, said sleeves 42 may be secured in place longitudinally by affixing end cap 43 to the distal end of connecting rod 41.

According to one embodiment, cleats 44 of tire connector bracket 40 may be sized and spaced to accommodate a secondary means of securing tire mounted accessory system 100 to a vehicle tire, such as a nylon ratchet strap. In this embodiment, with cleats 44 of a plurality of tire connector brackets 40 in contact with the outer tread surface of a vehicle tire, the ratchet strap may be looped over the sleeves 42 and tightened, securing tire mounted accessory system 100 with additional inward force from said ratchet strap. Such secondary means of securing tire mounted accessory system 100 to a vehicle tire are not limited to this example embodiment and may contemplate additional means of securing that are known in the art without departing from the spirit of this disclosure.

Another bracket 30 may take the form of a locking bracket 45. Locking bracket 45 may be in the form of a U-shaped bracket, having an upper horizontal side, a vertical side, and a lower horizontal side, with a pin 31 disposed on the inner face of the vertical side, a plurality of corresponding locking holes 32 disposed on any of the upper horizontal side, vertical side or lower side, and a vertical connecting bar 46 disposed on the outer face of either the upper horizontal side or the lower horizontal side.

According to one embodiment, locking bracket 45 is sized to be slidably inserted over tire connector bracket 40 affixed to horizontal rail 11, in order to further mechanically lock tire connector bracket 40 in its place on horizontal rail 11. This may be accomplished inserting pin 31 of locking bracket 45 into pinhole 21 located on the outer face horizontal rail 11, thus aligning corresponding locking holes 32 of locking bracket 45 so that a mechanical fastener may be inserted therebetween to secure locking bracket 45 in place.

Vertical connecting bar 46 may be used to connect vertical rail 12 to horizontal rail 11. According to one embodiment vertical connecting bar 46 includes one or more pinholes 21 as well as one or more locking holes 22. Vertical connecting bar 46 may be sized to be slidably inserted into vertical rail 12 such that one or more pinholes 21 and locking holes 22 may be aligned with one or more pinholes 21 and locking holes 22 located on a face of vertical rail 12. Once vertical connecting bar 46 is slidably inserted into a proximal or distal end of vertical rail 12, a pin 31 may be inserted into said pinholes 21, connecting vertical connecting bar 46 and vertical rail 12, and mechanical fasteners may be inserted into locking holes 22 to secure the pieces in place.

Tire mounted accessory system 100 may be installed on a wide variety of tire sizes and widths. On the low end, tire mounted accessory system 100 may be reduced in size to the length of vertical rail 12. On the high end, tire mounted accessory system 100 may be expanded to the length of vertical rail 12 and the maximum extension of vertical connecting bars 46 attached thereto. According to one embodiment, this may accommodate a tire having a diameter of 33 to 40 inches. However, additional tire sizes may be accommodated by using vertical rails 12 and vertical connecting bars 46 having greater or smaller lengths. Additionally, the terms vertical connecting rail 12 and horizontal connecting rail 11 are exemplary and do not limit the scope of this disclosure, as tire mounted accessory system may be installed on a vehicle tire at any angle, from 0° to 180°, such as with vertical rails 12 oriented horizontally and horizontal rails 11 oriented vertically, without altering the function of the device.

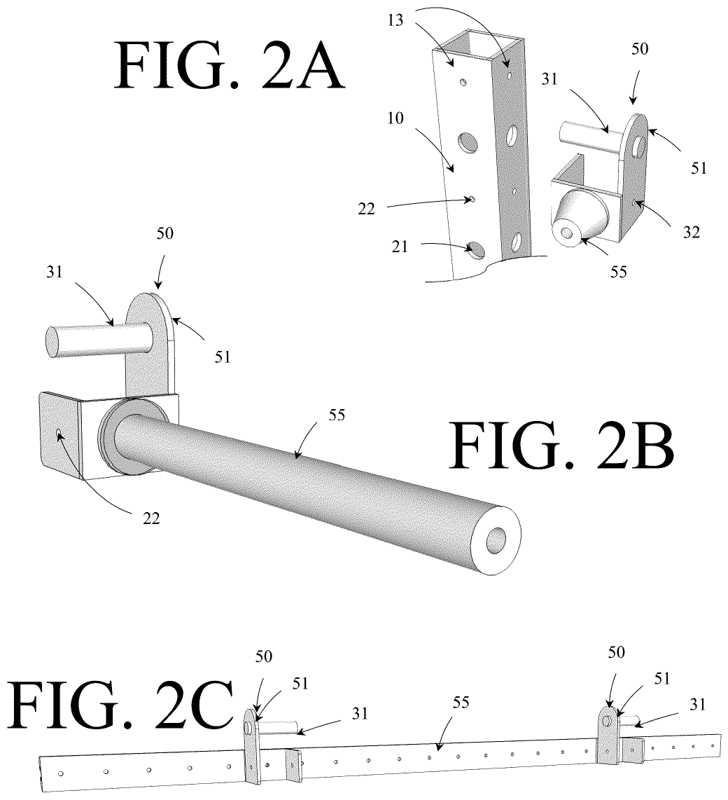

Referring to FIGS. 2A-C, another bracket 30 may take the form of a universal accessory bracket 50. Universal accessory bracket 50 may be in the form of a U-shaped bracket having a left side, a right side parallel to the left side, and face side perpendicular to the left side and right side, that may be sized to fit over rail 10 such that one or more inner surfaces of said universal accessory bracket 50 contacts one or more mounting surfaces 13 of rail 10. The left side, right side or face side of universal accessory bracket 50 may further include one or more corresponding locking holes 32 located on any of the left side, right side and face side, and may also include a pin flange 51, extending laterally from either the left side or right side of universal bracket 50 and further comprising a pin 31.

According to one embodiment, universal accessory bracket 50 may be connected to rail 10 by positioning said bracket with pin flange 51 facing towards rail 10, inserting pin 31 into pinhole 21 on mounting point 20 of rail 10, and rotating said bracket so that the inner surfaces of the left side, right side and face side contact one or more mounting surfaces 13. In this position, one or more corresponding locking holes 32 located on universal accessory bracket 50 are configured to align with one or more locking holes 22, allowing a mechanical fastener to be inserted therebetween, securing said bracket in place. Universal accessory bracket 50 may be removed by performing the same steps in reverse, removing any mechanical fasteners connecting locking holes 22 to corresponding locking holes 32, rotating universal accessory bracket 50 so that only pin 31 and pin flange 51 are in contact with rail 10, and removing said bracket by withdrawing pin 31 from pinhole 21.

Universal accessory bracket 50 may further be modified to accommodate a variety of accessories 55, which may be removably attached, such as by mechanical fasteners, or permanently attached, such as by welding, to one or more of the left side, right side or face side of said bracket.

Referring to FIG. 2A, accessory 55 may be in the form of a bumper 55A disposed on the outer surface of the face side of said bracket, configured to contact an outer surface of an automobile tire to provide cushioning, and prevent tire mounted accessory system 100 from damaging tire, rim or wheel. Bumper 55A may constructed of rubber, plastic, Teflon, or similar material known in the art.

Referring to FIG. 2B, accessory 55 may be in the form of a pole or rod of sufficient thickness and material strength to support the weight of an adult body and functioning as a step 55B, which may be used to help a user to reach items located high up or on top of the vehicle.

Referring to FIG. 2C, accessory 55 may be in the form of a rail or span 55C. In this configuration, two universal accessory brackets 50 may be located substantially parallel to one another, with span 55C disposed on the face side of each of said brackets, connecting them. So long as pin flanges 51 of both universal accessory brackets 50 are located on the same side of said brackets, such a span may be installed or removed from two parallel horizontal rails 11 or vertical rails 12 without disconnecting span 55C from said universal accessory brackets 50.

Accessory 55 is not limited to the specific examples discussed in this disclosure and may contemplate additional structures and functions that may be useful to the user of a vehicle having an externally mounted spare tire without departing from the spirit of this disclosure. Such accessories 55 may include jerry cans, stepladders, bicycle, ski or snowboard mounts, baskets or shelves.

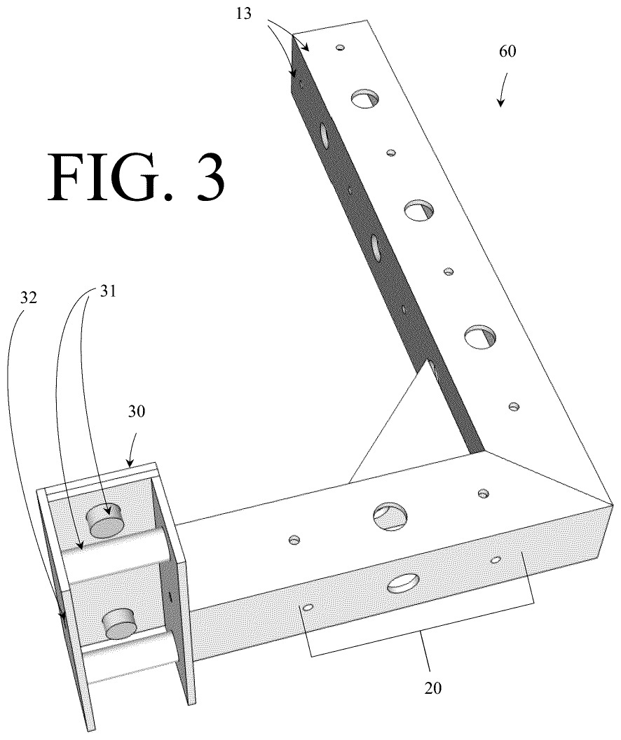

Referring to FIG. 3, tire mounted accessory system 100 may also accommodate one or more expansion legs 60. According to one embodiment, expansion leg 60 may be substantially L-shaped, having a proximal end connected to bracket 30 and a distal end perpendicular to said bracket, may be constructed of the same material as rails 10, and may have one or more mounting surfaces 13 each having a plurality of mounting points 20. A variety of bracket 30 designs may be used in connection with expansion leg 60, including any of the aforementioned brackets 30, or a combination of the aforementioned brackets 30.

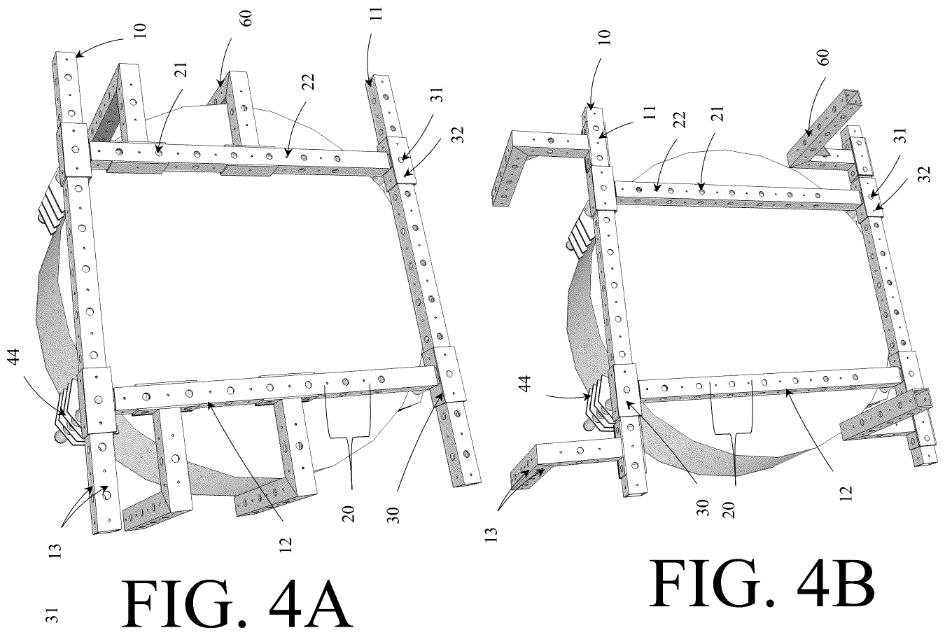

Referring to FIG. 4A, according to one embodiment, one or more expansion legs 60 may be installed on vertical rail 12 with their distal ends oriented forward relative to the direction of the vehicle. In this configuration, expansion legs 60 would allow additional universal accessory brackets 50 or other compatible devices or brackets to be affixed along the side of the vehicle tire. In this example the accessory may be a jerry can. But other accessories such as MOLLE panels, tool mounts, signs, display items or other devices may be contemplated without departing from the spirit of this disclosure.

Referring to FIG. 4B, according to another embodiment, two expansion legs 60 may be installed parallel to one another on horizontal rail 11 located near the top of a vehicle tire to provide a flat, horizontal surface sufficient to support a table or basket. Alternatively, two expansion legs 60 may be installed parallel to one another on a pair of vertical rails 12, with the proximal ends of said expansion leg extending laterally from said vertical rails 12 and the distal ends oriented rearward relative to the direction of the vehicle, forming a platform suitable for a table or shelf. Whether expansion legs 60 are installed on vertical rails 12 or horizontal rails 11 is at the user's discretion. Expansion legs 60 may be installed on any mounting points 20 available to form a stable horizontal surface.

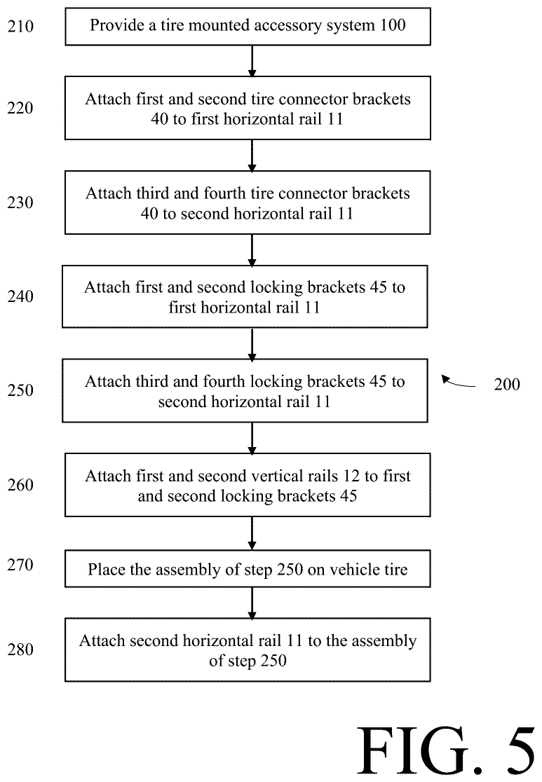

Referring to FIG. 5, a method 200 of attaching a tire mounted accessory system 100 to a vehicle tire 90 is described. In step 210, a tire mounted accessory system 100 comprising a first and second horizontal rail 11, a first and second vertical rail 12 are provided, each having a top end and a bottom end, a first, second, third and fourth tire connector bracket 40 each having a plurality of cleats, and a first, second, third and fourth locking bracket 45 each having a vertical connecting bar 46. In step 220, the first and second tire connector brackets 40 are attached to substantially opposite ends of the first horizontal rail 11, spaced apart at distance substantially less than the diameter of the vehicle tire. In step 230 the third and fourth tire connector brackets 40 are attached to substantially opposite ends of the second horizontal rail 11, spaced apart at the same distance as the first and second tire connector brackets 40. In step 240, the first and second locking brackets 45 are affixed to the first horizontal rail 11 over the first and second tire connector brackets 40, with the vertical connecting bars 46 of each of said locking bracket 45 orient downward relative to the ground. In step 250, the third and fourth locking brackets 45 are affixed to the second horizontal rail 11 over the third and fourth tire connector brackets 40, with the vertical connecting bars 46 of each of said locking brackets oriented upward relative to the ground. In step 260, the top ends of the first and second vertical rails 12 are affixed to the first and second locking brackets 45 by slidably inserting said rails into the vertical connecting bars 46 of each of said locking brackets 40. In step 270, the assembly of step 250 is placed upon a vehicle tire such that the cleats of the first and second tire connector brackets 45 contact the tread surface of the vehicle tire. In step 280, the second horizontal rail 11 is attached to the assembly of step 250 by slidably inserting the third and fourth vertical connecting bars 46 into the bottom ends of the first and second vertical rails 12 until the cleats of the third and fourth tire connector brackets 40 contact the tread surface of the vehicle tire.

Having now described some illustrative embodiments, it is apparent that the foregoing is illustrative and not limiting, having been presented by way of example. In particular, although many of the examples presented herein involve specific combinations of elements, those elements may be combined in other combinations. Elements and features discussed only in connection with one embodiment are not intended to be excluded from other embodiments.

Any references to front and back, left and right, top and bottom, or upper and lower and the like are intended for convenience of description, not to limit the present systems and methods or their components to any one positional or spatial orientation.

Any references to embodiments or elements herein referred to in the singular may also embrace embodiments including a plurality of these elements, and any references in plural to any embodiment or element herein may also embrace embodiments including only a single element. References in the singular or plural form are not intended to limit the presently disclosed components or elements to single or plural configurations.

Any embodiment disclosed herein may be combined with any other embodiment, and references to “an embodiment,” “some embodiments,” “an alternate embodiment,” “various embodiments,” “one embodiment” or the like are not necessarily mutually exclusive and are intended to indicate that a particular feature or characteristic described in connection with the embodiment may be included in at least one embodiment. Such terms as used herein are not necessarily all referring to the same embodiment. Any embodiment may be combined with any other embodiment, inclusively or exclusively, in any manner consistent with the aspects and embodiments disclosed herein.

What is claimed is:

1. A tire mounted accessory system comprising:
A first horizontal rail having at least one mounting point comprising a pinhole,
A second horizontal rail substantially parallel to the first horizontal rail, having at least one mounting point comprising a pinhole,
A first vertical rail oriented substantially perpendicular to the first horizontal rail and second horizontal rail, having at least one mounting point comprising a pinhole,
A second vertical rail oriented substantially parallel to the first vertical rail and substantially perpendicular to the first horizontal rail and second horizontal rail, having at least one mounting point comprising a pinhole, and
A first tire connector connected to a mounting point.

2. The tire mounted accessory system of claim 1, further comprising at least one accessory connected to a mounting point.

3. The tire mounted accessory system of claim 2, wherein the accessory is selected from a group comprising, a bumper, a span, a basket, or a bicycle rack.

4. The tire mounted accessory system of claim 1, wherein the tire connector is connected to the mounting point via a bracket.

5. The tire mounted accessory system of claim 1, wherein the first vertical rail is connected to the first horizontal rail or the second horizontal rail via a vertical connecting bar.

6. The tire mounted accessory system of claim 1, further comprising a second tire connector, a third tire connector and a fourth tire connector, wherein each said tire connector is positioned at the intersection of one of the first or second vertical rails and one of the first or second horizontal rails.

7. The tire mounted accessory system of claim 1, further comprising a first expansion leg having at least one mounting point, connected to one of the first horizontal rail, second horizontal rail, or first vertical rail via a bracket.

8. The tire mounted accessory system of claim 7, further comprising an accessory connected to the first expansion leg via at least one mounting point.

9. The tire mounted accessory system of claim 7, further comprising a second expansion leg having at least one mounting point, and an accessory connected to at least one mounting point of the first expansion leg via, and at least one mounting point of the second expansion leg.

10. A method of installing a tire mounted accessory system on an automobile tire, comprising:
Providing a tire mounted accessory system including a first horizontal rail, a second horizontal rail, a first vertical rail, a second vertical rail, a first tire connector, a second tire connector, a third tire connector, and a fourth tire connector,
Attaching the first vertical rail to a first end of the first horizontal rail, and a second vertical rail to a second end of the first horizontal rail substantially opposite to the first horizontal rail using a bracket,
Attaching the first tire connector at the intersection of the first vertical rail and first horizontal rail, and the second tire connector at the intersection of the second vertical rail and first horizontal rail,
Placing the first tire connector and second tire connector in contact with an automobile tire,
Orienting the second horizontal rail parallel to the first horizontal rail and attaching said second horizontal rail to the first vertical rail, and attaching the second horizontal rail to the second vertical rail, and
Attaching the third tire connector at the intersection of the first vertical rail and second horizontal rail, and the second tire connector at the intersection of the second vertical rail and second horizontal rail, such that the third tire connector and fourth tire connector are in contact with an automobile tire.
